(19) United States
(12) Patent Application Publication
(10) Pub. No.: US 2006/0153305 A1
(43) Pub. Date: Jul. 13, 2006

(54) Device for the trans-compression of a digital audiovisual stream in order to adapt same to existing television equipment

(76) Inventor: Philippe Guenebaud, Saint Cyr Sur Mer (FR)

Correspondence Address: GREENBLUM & BERNSTEIN, P.L.C., 1950 ROLAND CLARKE PLACE, RESTON, VA, 20191, US

(21) Appl. No.: 10/533,079

(22) PCT Filed: Oct. 27, 2003
(86) PCT No.: PCT/FR03/03177

§ 371 Date: Nov. 28, 2005

(30) Foreign Application Priority Data
Oct. 28, 2002 (FR) 02/13451

(51) Int. Cl. H04N 7/12; H04N 11/04; H04B 1/66; H04N 11/02

(52) U.S. Cl. 375/240.26; 375/240.12

(57) ABSTRACT

The invention relates to a device which can be used for on-the-fly conversion, using a new, unknown method involving the receiver already in place at the user's premises, of a low-bandwidth digital audiovisual stream which is highly compressed (for transport reasons) into another digital audiovisual stream which is less compressed but which is perfectly adapted to the receiver in place responsible for performing same. The inventive device is particularly adapted to open receivers and modules which are compatible with the DVB-CI standard.

The present invention relates to the adaptation of a digital audiovisual stream trans-compression device to existing television equipments.

For years, broadcasting and reception architectures for digital audiovisual programs have practically all been based on the MPEG2 compression and transport (such as ISO/IEC 13818-1, for example) and DVB standards, which were then implemented with the initial goal to standardize equipments, and especially to reduce the digital bandwidth (in order to reduce cost and provide more programs). This technology is used to equip satellite or cable broadcasting and reception stations, and more recently, for the digital terrestrial television.

A “pure” digital stream would “weigh” several tens of Mega bits per second, while a digital stream compressed according to the initial state of the art was reduced to a few Mega bits per second. Compression was defined more than 10 years ago, and the type that is the most widely used in the audiovisual industry is still MPEG2 in the “Main Profile at Main Level” (MP@ML) mode.

The reception and decoding equipments of individual users, which are compatible with MPEG2 MP@ML, such as digital receivers, also called decoders, make it possible to decompress the video and the audio so that they can be played on television sets (after analog conversion). These equipments will be referred to as the “Receiver” in the remainder of this disclosure.

Unfortunately, if an Operator, today, wished to reduce broadcasting costs by limiting his bandwidth while maintaining the same programming quality, or wished to increase the number of channels for the same bandwidth, using the new audio and video compression technologies, he would have to replace all of said existing receivers installed at the individual users' premises. Indeed, said receivers all have hardwired components (hardware) and would not support these new compression modes.

The same goes for a new regional or associative operator, with a limited budget, who would have to pay the broadcasting cost at full rate while, for the same broadcasting quality, his access fee could be 10 times less due to the evolving new technologies used on the Internet (such as MPEG4, H264, Windows Media 9, etc. . . . ). Indeed, the constantly evolving PC platforms can more readily be adapted to new software and even hardware upgrades.

A solution to this problem is the Device according to the invention, which enables the on-the-fly conversion of a low bandwidth digital audiovisual stream, highly compressed (for transport purposes) according to a recent method unknown to the receiver already installed at the user's premises, into another digital audiovisual stream which is less compressed but perfectly adapted (using MPEG2 compression, for example) to said installed receiver designated for playing the same.

The Device, according to a particular embodiment of the invention, can be a DVB-CI (CENELEC EN50221) standard-compliant removable module, to be connected to a PCMCIA slot of an “open” receiver that is DVB-CI compatible. Several million units of this type of “open” receivers are already in use worldwide.

The Device, according to another particular embodiment of the invention, can also be directly integrated into a “closed” or DVB-CI “open” standard-compliant reception equipment, in the form of components (chip set) or additional card. The addition of said Device does not in any way disturb the other vital functions of the receiver, such as the tuner, man-machine interface (MMI and OSD), access control (CAS), interactive engines, PAL/SECDAM encoder, etc. . . . and only requires minimal effort for integration.

The Device according to the invention can be adapted to operators' current and specific needs, by customizing it at the level of the desired compression, but also to their future needs, if it has additional machine power and a flexible and clever architecture, enabling its improvement through software updates (local or downloaded “over the air”), for example.

By way of a non-limiting example of implementation, said Device could easily be made on the basis of a programmable DSP, with its memory and its associated hardware accelerators.

The Device, according to another embodiment of the invention, can have the descrambling function, with or without a chip card, even if it is not its primary function. In any case, the function of the Device according to the invention must be positioned after the function of descrambling the useful packets.

The advantages of the invention lie in the fact that by transforming an aging receiver into an upgradeable device that is always at the “top of the technology”, it offers a reasonable access fee to new broadcasting operators or a dramatic cost reduction to those who are already operating, by using all the broadcasting and reception infrastructure that has already been in use for many years.

In addition, it does not change the model of the operators which were installed to control access by scrambling, since the packets are still transmitted in MPEG2 (encapsulated).

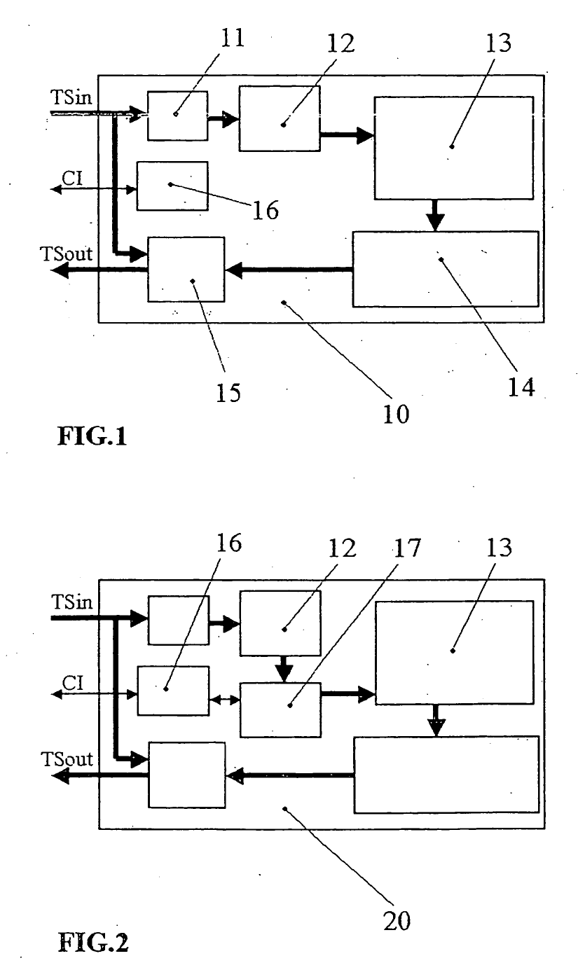

FIG. 1 shows a possible implementation according to the invention. The DVB-CI module (10) shown, which connects to a DVB-CI receiver, is broken down into a plurality of functional units.

The synchronization of said module (10) with said receiver, to which it is connected, is done by means of the CI unit (16) in compliance with the DVB-CI standard.

The standardized complete TSin stream, coming from said receiver, enters the unit (11) for filtering and extracting the useful packets and comes out demultiplexed, due to the identification of said packets (“Paquet IDentifier” or PID).

It then enters the unit (12) for decapsulating the useful stream.

Said useful stream then enters the audio/video decompression unit (13), which is specific to the broadcasting operator's needs, and then comes out, no longer compressed at all, at a very high bandwidth (that can reach up to 100 Mbit/s depending on the quality).

This uncompressed stream then goes through the MPEG2 recompression unit (14) so that it can be understood by the MPEG2 Receiver that will play it. It must be noted that the computing power necessary for this re-compression does not need to be very high because this newly compressed MPEG2 stream does not need to be transported but only needs to be used locally. It is quite possible to only compress the stream in i-frames, and that the motion prediction (which is computing power intensive) be reduced to its bare minimum (no or very few “p-frames”, and/or “b-frames”).

Finally, said re-compressed MPEG2 stream is re-injected by multiplexing in the TSout output stream, returning to said receiver, due to the MPEG2 re-encapsulation unit (15), instead of the initially useful stream (too compressed) on the same PIDs, or as a supplement to the initial useful stream on other predetermined PIDs, respecting the time stamps and taking care not to desynchronize the video and the audio.

The new MPEG2 packets thus reconstituted have a higher volume than those of the “highly compressed” initial useful stream, and they have to be injected during the stream inactivity periods or, if necessary, in lieu of audio/video packets that do not relate to the viewing of the program in progress.

FIG. 2 describes a particular embodiment of another DVB-CI module (20) according to the invention. In addition to the functions that are identical to those described in FIG. 1, said module (20) can temporarily or permanently store the “highly compressed” stream in a local or remote buffer memory (17), and can replay it at the user's request, thereby performing the conventional functions of the digital videotape recorder, for example, including but not limited to, pause, fast forward, rewind, recording, etc. while using the control and viewing commands which are made available by the receiver to which it is connected.

The control by the user is made possible due to the standard functions of any DVB-CI standard-compliant receiver. Indeed, such a receiver can transmit the information received from a remote control to any DVB-CI compatible module and, in particular, to said module (20) by means of the CI control unit (16); and said module (20) can in turn notify or prompt the user due to the display in MMI mode on the screen of the TV connected to said receiver and controlled by said DVB-CI compatible module (20), via the same communication channel but in reverse direction.

According to various embodiments of the Device according to the invention, the latter, which enables the on-the-fly conversion of a low bandwidth digital audiovisual stream, highly compressed for transport purposes, into a less compressed digital audiovisual stream in order to adapt it to the existing equipments designated for playing the same, can:
extract the “highly compressed” useful stream, encapsulated in transport packets (MPEG2, for example) that can be identified (by PID, for example) from an input Transport stream (TSin, for example),
decompress said useful stream into a non-compressed digital stream (of the “bitmap” type for the video, for example),
slightly but sufficiently re-compress the new non-compressed digital stream (in MPEG2, for example),
re-encapsulate the resulting new stream into transport packets (MPEG2, for example),
re-inject said packets into the output Transport stream (TSout, for example) while respecting the time stamps and taking care not to desynchronize the video and the audio,
return to said receiver said re-compressed and re-encapsulated packets which are re-injected by multiplexing into the Transport stream in lieu of the initial useful stream packets, and with the same packet identifications (PIDs, for example),
return to said receiver said re-compressed and re-encapsulated packets which are re-injected by multiplexing into the Transport stream as a supplement to the packets of the initial useful stream (which is unusable) with other predetermined packet identifications (PIDs, for example),
filter and simply eliminate some of the audio/video packets of the initial input Transport stream identified as not being related to the viewing or the listening of the selected program in progress, in order to “create space” in the output Transport stream,
temporarily or permanently store the “highly compressed” useful stream in a local or remote memory (17) and replay it at the user's request, thus performing the conventional functions of a digital video recorder,
perform the function of descrambling the useful stream before carrying out its main function of trans-compression,
be integrated into a PCMCIA removable module compatible with the DVB-CI (CENELEC EN50221) standard,
be integrated into existing equipment in the form of component(s) or card(s) to be connected.

1. Device enabling the on-the-fly conversion of a low bandwidth digital audiovisual stream, which is highly compressed for transport purposes, into a less compressed digital audiovisual stream, in order to adapt it to existing equipments designated to play the same, characterized in that it successively:
extracts the “highly compressed” useful stream encapsulated in transport packets (MPEG2, by way of non-limiting example) that are identifiable (by PID, by way of non-limiting example), from an input transport stream (TSin, by way of non-limiting example),
decompresses said useful stream into a less-compressed or non-compressed digital stream (of the video “bitmap” type, by way of non-limiting example),
re-compresses sufficiently the new less-compressed or non-compressed digital stream in a format that is known to the equipment designated for playing it (in MPEG2, by way of non-limiting example)
re-encapsulates the new resulting stream in transport packets (MPEG2, by way of non-limiting example),
re-injects said packets in the output Transport stream (TSout, by way of non-limiting example), taking care not to desynchronize the video and the audio.

2. Device according to claim 1, characterized in that said re-compressed and re-encapsulated packets, which are re-injected by multiplexing into the Transport stream, return to said receiver in lieu of the initial useful stream packets, possibly with the same packet identifications (PIDs, by way of non-limiting example), then modifying the output stream bandwidth.

3. Device according to claim 1, characterized in that said re-compressed and re-encapsulated packets, which are re-injected by multiplexing into the Transport stream, return to said receiver as a supplement to the initial useful stream packets (while also keeping the initial packets that were used to generate the new stream but which have become useless), with other packet identifications (PIDs, by way of non-limiting example).

4. Device according to claim 1, characterized in that it filters and simply eliminates some of the audio/video packets of the initial input Transport stream, identified as not being related to the viewing or the listening of the selected program in progress, in order to “create space” in the output Transport stream.

5. Device enabling the use of the conventional functions of a digital video recorder, by being capable of temporarily or permanently storing all or the useful portion of the “highly compressed” initial stream in a local or remote memory (17), in order to replay it at the user's request, characterized in that it implements the device according to claim 1, for its decompression, re-compression in a known format, re-encapsulation and, finally, re-injection in the output transport stream.

6. Device, characterized in that it performs the function of descrambling the useful stream before carrying out its main function of adapting the output transport stream, according to claim 1.

7. Device according to claim 1, characterized in that it is integrated, entirely or partially, into a removable peripheral (including but not limited to a PCMCIA module compatible with the DVB-CI CENELEC EN50221 standard, or the OpenCable POD standard, a removable USB port or parallel Port, an Ethernet extension, etc. . . . ).

8. Device according to claim 1, characterized in that it is integrated, entirely or partially, into existing equipment, in the form of component(s) or card(s) to be connected, in order to recreate a real transport stream capable of being played by the existing and especially standard means of said equipment.
